(19) United States
(12) Patent Application Publication
(10) Pub. No.: US 2007/0061193 A1
(43) Pub. Date: Mar. 15, 2007

(54) Advertisement on demand service

(76) Inventors: Michael Libonati, Barnegat, NJ (US); Marcus P. Bunz, Ocean, NJ (US); Fred W. Russell, Monroe Township, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/222,879

(22) Filed: Sep. 9, 2005

(51) Int. Cl. G06Q 30/00

(52) U.S. Cl. 705/14

(57) ABSTRACT

A method for distributing advertisements. The method comprises initiating a telephone call from a telephone and sending a request for an advertisement from the telephone, the request including a unique identifier associated with the advertisement and a telephone number associated with the telephone. The request is received at server for further processing. If the user is a registered user, then the ad is sent to the user's personal computer. If the user is not registered, then further processing enables the user to be registered. The ad is thereafter sent to the user.

### BACKGROUND OF THE INVENTION

The present invention generally relates to the provision of advertisements over a communication network and, more particularly, to an advertisement-on-demand or ad-on-demand service that is accessible over a public telephone or data network.

Many different forms of advertising are in use today. These include providing advertisements to consumers through the use of billboards, radio and television commercials, email messages and pop-up ads. Billboards and radio/television commercials represent the more traditional forms of advertising. It has always been difficult to gauge the effectiveness of these traditional forms of advertising for a variety of reasons. For example, consumers have always been able to avoid a television or radio commercial by changing the television or radio station.

Even when the consumer does not change the station, it is still difficult to gauge the effectiveness of the more traditional forms of advertising. For example, the user may not respond to the ad either because of a lack of interest or if interested, because the information contained was not recorded by the user and therefore lost. Furthermore, in general, these systems generally do not provide a way to track whether users are responding to a particular ad. In addition, with the availability of digital video recorders and satellite radio consumers may avoid exposure to television and radio commercials altogether.

Originally, the less traditional or electronic forms of advertisement, e.g., email messages, pop-up ads, were thought to hold great promise for delivering targeted advertisements and tracking responses to such advertisement. These forms of advertising have also proven to be less effective than originally thought. For example, the availability of SPAM filters and the like allows a consumer to filter email from unwanted sources. In particular, a SPAM filter prevents certain email messages from reaching a user's email account based on the email address of the message. These filters therefore prevent much of the advertising that is created from ever reaching its intended source. Filters for pop-ups have proven to be equally effective.

Even in view of the foregoing obstacles, advertisers and their customers continue to spend large sums of money on advertising. On the other hand, consumer response to advertisement continues to generally be the same. That is, a consumer only wants to receive advertisements of interest. Furthermore, where an advertisement of interest is available to the consumer via non-electronic means and the consumer wants to respond to the ad in some way, e.g., visit a store or web site referred by the ad, the referral information is usually not retained by the consumer.

Of utility then are methods and systems that allow advertisers and their customers to gauge the effectiveness of advertisements; and consumers to selectively receive and retain information relating to only those advertisements of interest.

### SUMMARY OF THE INVENTION

An aspect of the present invention is a method for distributing advertisements. The method preferably comprises initiating a telephone call from a telephone and sending a request for an advertisement from the telephone, the request including a unique identifier associated with the advertisement and a telephone number associated with the telephone. The request is then received at a network server. The server then preferably processes the request by determining whether the telephone number is associated with a registered user. The advertisement may then be transmitted from the network server to an account associated with the registered user if the server determines that the telephone number is associated with a registered user.

Further in accordance with this aspect of the present invention, the method further desirably comprises routing the telephone call to a registration server if the server determines that the telephone number is not associated with a registered user. The method may also further comprise registering, at the registration server, the user's telephone number as a registered user. Furthermore, registering preferably comprises sending a confirmation message to a personal computer associated with the user over the Internet.

Further in accordance with this aspect of the present invention, sending preferably further comprises sending the request to the server over a telecommunications network employing advanced intelligent network technology. In addition, the advanced intelligent network technology preferably comprises a service control point having a generic data interface that is connected to the server.

Further still in accordance with this aspect of the present invention, transmitting desirably comprises sending an email that includes the advertisement over the Internet to an email account associated with the registered user.

Preferably, the telephone call is initiated over a cellular telephone network, but may also be initiated over a wireline or landline telephone network. Most preferably, the landline telephone network comprises a public switched telephone network.

In another aspect, the present invention is a method for providing an ad-on-demand service. The method preferably comprises receiving an ad-on-demand request from a telephone at telephone switching system; routing the ad-on-demand request from the telephone switching system to an integrated service control point; transforming, at the integrated service control point, the ad-on-demand request into one or more data packets; and sending the one or more data packets to a server. Further in accordance with this aspect of the present invention, the method also comprises processing, at the server, the one or data packets to determine whether an ad associated with the ad-on-demand request should be routed to a client computer associated with the telephone.

Further in accordance with this aspect of the present invention, the ad-on-demand request comprises a telephone number associated with the telephone and ad-on-demand identifier associated with a product or a service.

Further in accordance with this aspect of the present invention, sending preferably comprises sending the one or more packets using the TCP/IP protocol. Further still, routing comprises routing one or more messages associated with the ad-on demand request over a signaling network.

It also desirable that the signaling network comprises a switching system seven (SS7) signaling transfer point. In addition, processing may further comprise sending an email message to a computer connected to the server and associated with the telephone over a data communication network distinct from a telephone network comprising the telephone switching system and the integrated service control point if the telephone number is associated with a registered user.

Further still in accordance with this aspect of the present invention, the data communication network comprises the Internet and the telephone network comprises the public switched telephone network. In addition, processing may further comprise sending an audible message to the telephone over the telephone network if the telephone number cannot be associated with a registered user.

In accordance with this aspect of the present invention, receiving the ad-on-demand request preferably comprises receiving a telephone number associated with the ad-on-demand service. It may also be desirable that the method further comprises, prior to routing the ad-on-demand request, requesting ad-on-demand identifier associated with a product or a service.

### BRIEF DESCRIPTION OF THE DRAWINGS

FIG. 1 illustratively depicts a system in accordance with an aspect of the present invention.

FIG. 2A illustratively depicts a flow diagram of a process in accordance with an aspect of the present invention.

FIG. 2B illustratively depicts a system that shows a process flow in accordance with an aspect of the present invention.

FIG. 3 illustratively depicts a user registration page in accordance with an aspect of the present invention.

FIG. 4A illustratively depicts a flow diagram of a process in accordance with an aspect of the present invention.

FIG. 4B illustratively depicts a system showing a flow diagram of a process in accordance with an aspect of the present invention.

### DETAILED DESCRIPTION

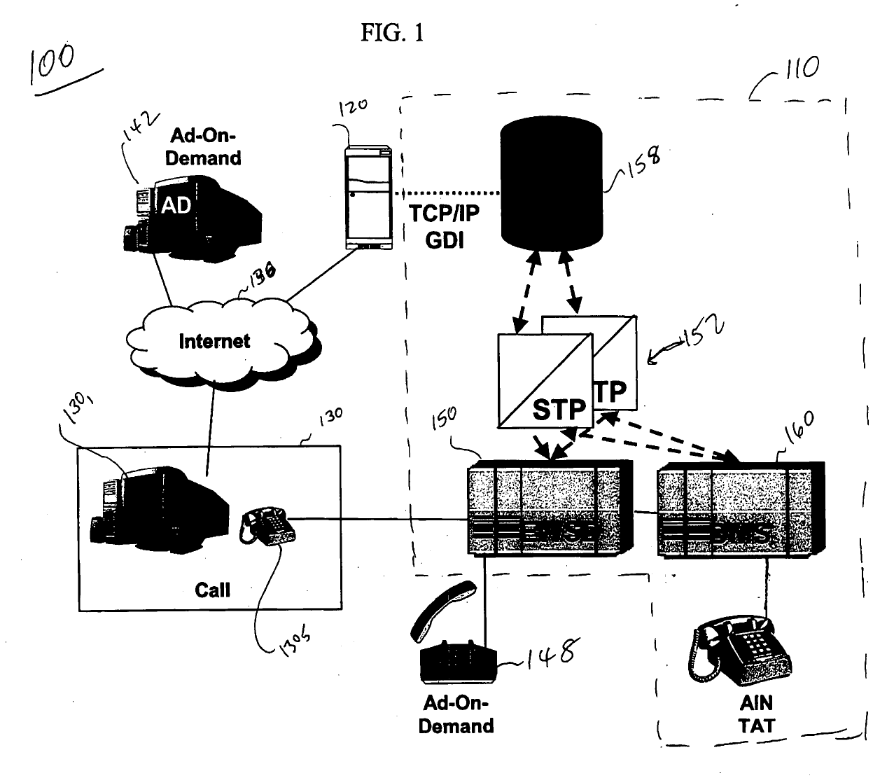

FIG. 1 illustratively depicts a system 100 in accordance with an aspect of the present invention. The system 100 includes a telephone network 110 that is connected to data server 120 and a call center 130. The data server 120 and call center 130 are further connected to each other through a data communication network 136. The system 100 further includes a computer 142 that is connected to the data server 120 and call center 130 through the communication network 136. The system further includes a telephone 148, which is connected to the telephone network 110.

In particular, the telephone 148 is connected the telephone network via a switching subsystem 150. The telephone 148 may comprise a wireline or wireless telephone. The switching subsystem 150 may comprise a digital switching system such as, for example, the Siemens EWSD switching system. In general, the subsystem 150 comprises hardware and software that can be used to switch or route voice or data between the ports on the switch. The subsystem 150 is also connected to a signaling transfer point 152. The signaling transfer point 152 preferably comprises a system implemented in accordance with the Common Channel Signaling System No. 7 or SS7 standard. The standard defines the procedures and protocol by which network elements in the public switched telephone network (PSTN) exchange information over a digital signaling network to effect wireless (cellular) and wireline call setup, routing and control. The SS7 network and protocol are used for example for: basic call setup, management, and tear down; wireless services such as personal communications services (PCS), wireless roaming, and mobile subscriber authentication; toll-free (800/888) and toll (900) wireline services. In accordance with the preferred embodiment, the SS7 network is preferably used to establish a toll-free service such as an 800 or 888 number service.

In accordance with the SS7 standard or network, the switch 150 may be considered to be a service switching point or end node equipped with SS7 software that sends signaling messages to other SSPs or to STPs 152 to setup, manage, and release the voice circuits required to complete a call. The STP 152 is a signal packet switch (or router) that receives and routes incoming signaling messages onward to their destinations.

As shown, the STP 152 is preferably connected to an integrated service control point 158. Generally, the integrated service control point 158 may comprise a centralized database that determines how the messages it receives from the STP 152 should be routed. In general, the integrated service control point 158 includes one or more call processing records that establish calling routes in a network. Additional operation details relating to the integrated service control point 158 are included in U.S. Pat. No. 5,751,961, the disclosure of which is hereby incorporated herein by reference. As shown, the ISCP 158 is connected to the server 120 via a generic data interface (GDI), which allows the ISCP 158 to connect to the server via transport convergence protocol/internet protocol (TCP/IP). In general, the GDI allows TCAP data to run over TCP/IP and therefore provides an interface for connecting to the server 120.

The server 120 comprises a computer system that processes database queries. In particular, the server preferably includes one or more databases that store a plurality of advertisements relating to products or services. The database may be a relational database that cross-references advertisements based on a product or service type, a company or manufacturer, technology, user or consumer demographics, etc. Each advertisement is preferably uniquely identified in the database using an identification code or the like. It should be noted that although one server 120 is shown in FIG. 1, the server may comprise a group of computer systems or servers that in addition to providing a database query function, may also include additional hardware and software to transmit data to the other equipment to which it is connected. For example, the server 120 may include an email server for preparing and sending email messages to client computer 142.

The server 120 is preferably connected to client computer 142 over the communication network 136. The communication network 136 preferably comprises the Internet. In general, the Internet is a global collection of networks that provide ubiquitous access to various types of information and allows users to communicate over expansive geographic areas, i.e., the geography of the earth. In that regard, the Internet provides a convenient means for users to access, gather and share information. Such information is typically stored on a collection of geographically scattered servers, which provide services to other machines, such as personal computers or clients and other servers, which comprise the Internet. Typically, the Internet is accessed from a web client application running on a personal computer, such as client computer 142. Client computer 142 may comprise a desktop computer as shown or a laptop. It may also comprise a personal digital assistant or any other device that can receive information from the Internet.

As shown, client computer 142 is also capable of communicating with the call center 130. The call center 130 includes a computer 130, and telephone 1305. As shown, the telephone 1305 is coupled to the switch 150. In addition, the switch 150 is also preferably connected to another digital switching system 160. In the preferred embodiment, the switching system 160 is coupled to a line subscribed to an advanced intelligent network termination attempt trigger 164.

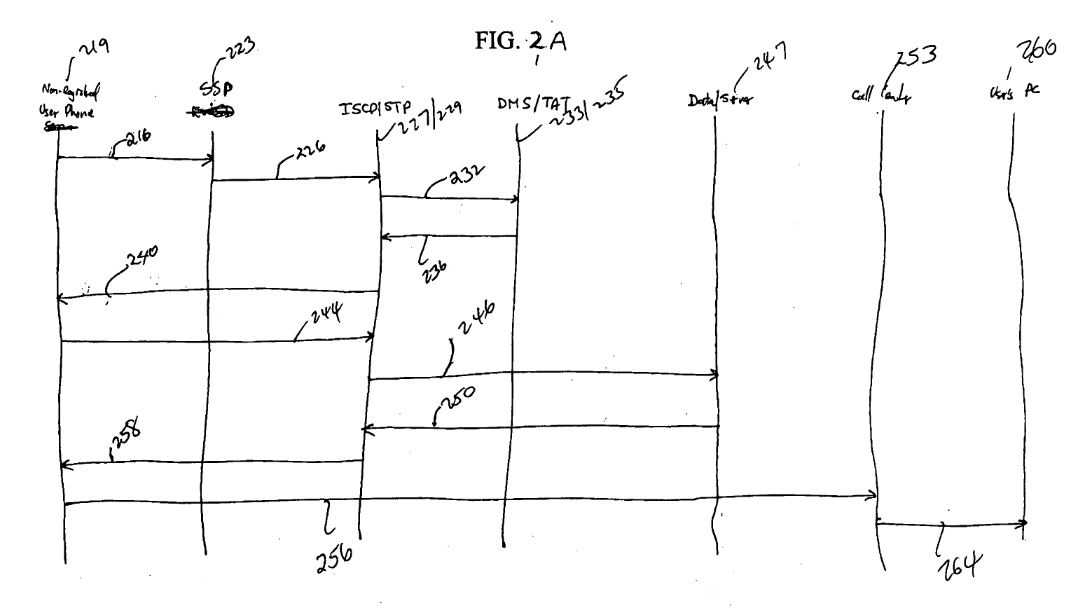

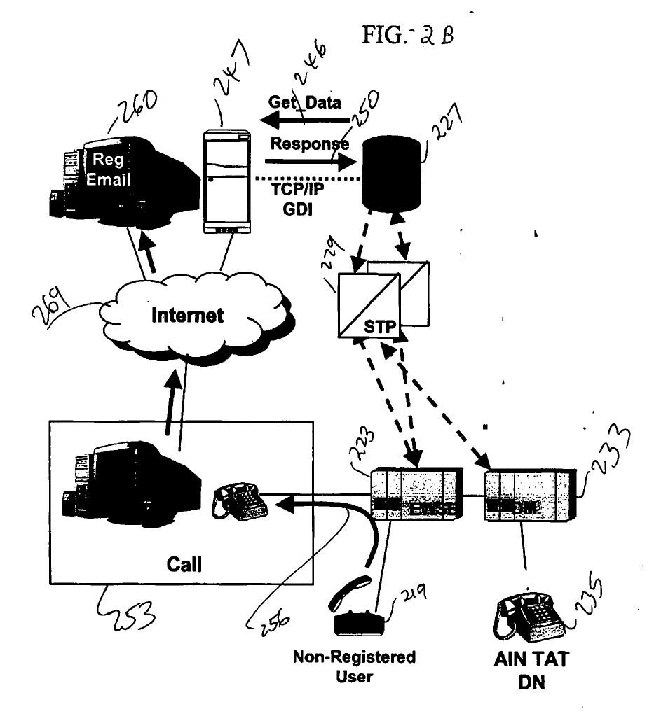

Turning now to FIGS. 2A and 2B, there is shown a flow diagram 200 and a reference diagram 210 that together illustrate a process flow in accordance with an aspect of the present invention. In accordance with FIG. 2A, the flow diagram 200 begins with a request from an unregistered user for an ad-on-demand, 216. The request 216 is preferably initiated using via telephone call from telephone 219. The request 216 may be initiated using an 800 or 888 number, e.g., 888-AD-ON-DMD. The request 216 is received at a service switching point 223. As previously discussed, the service switching point 223 comprises a EWSD switch in the preferred embodiment. The service switching point 223 then launches an advanced intelligent network specific data string (SDS) trigger 226 to an integrated service control point 227. As shown in FIG. 2A, the SDS trigger 226 is preferably routed through a STP 229 as discussed above.

The ISCP 227 then routes the call 232 to a switch 233 having line subscribed to an advanced intelligent networking termination attempt trigger 235. The switch 233 then initiates advanced intelligent networking termination attempt trigger query 236 to the ISCP 227. The ISCP 227 then requests that the user enter a unique identifier associated with the advertisement of interest 240. The unique identifier may comprise any combination of alphanumeric characters that can be entered via a phone, such as phone 219. For example, unique identifiers such as 4000 or AN4000 would suffice.

The user's response to the query 240 is shown as response 244. The ISCP then provides the unique identifier associated with the ad and information sufficient to identify the caller, 246, to the server 247. The information to identify the caller may, for example, include the calling number. In the process flow 200 illustrated in FIG. 2A, the caller or calling number is not identified by the server 247. The server therefore responds to the ISCP 227 at step 250 with an indication that the user is unregistered. The ISCP 227 then directs the call to the call center 253 for registration, 256. In addition, prior to forwarding the call to the call center 253, the ISCP 227 may also play a recording for the user, 258, requesting that they register with the call center 253. Once registration is completed, the call center 253 then sends a verification to the user's computer 259 as at step or line 264. As is best seen in FIG. 2B, the call center 253 and user computer 260 desirably communicate over a data communication network 269, such as the Internet.

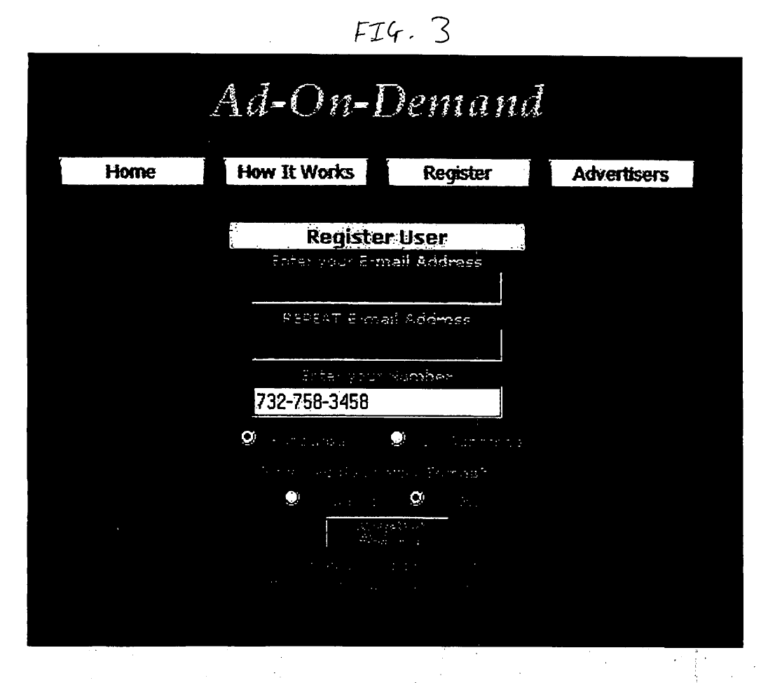

FIG. 3 shows an example of web page that a user may see when requested to register as, for example, at step 256. As shown, the user will be requested to input an email address and a phone number. In addition to these inputs, the user may also subscribe to a newsletter. The web page also includes additional buttons such as Home, How It Works, Register and Advertisers. The Home button links to a home web page. The How It Works button preferably links to a web page that describes the ad-on-demand service. The Register button provides a link to the page shown in FIG. 3. The Advertisers button preferably links to a web page that allows advertiser to register, upload and update their advertising and download data relating to the use of their advertising, e.g., the number hits, etc.

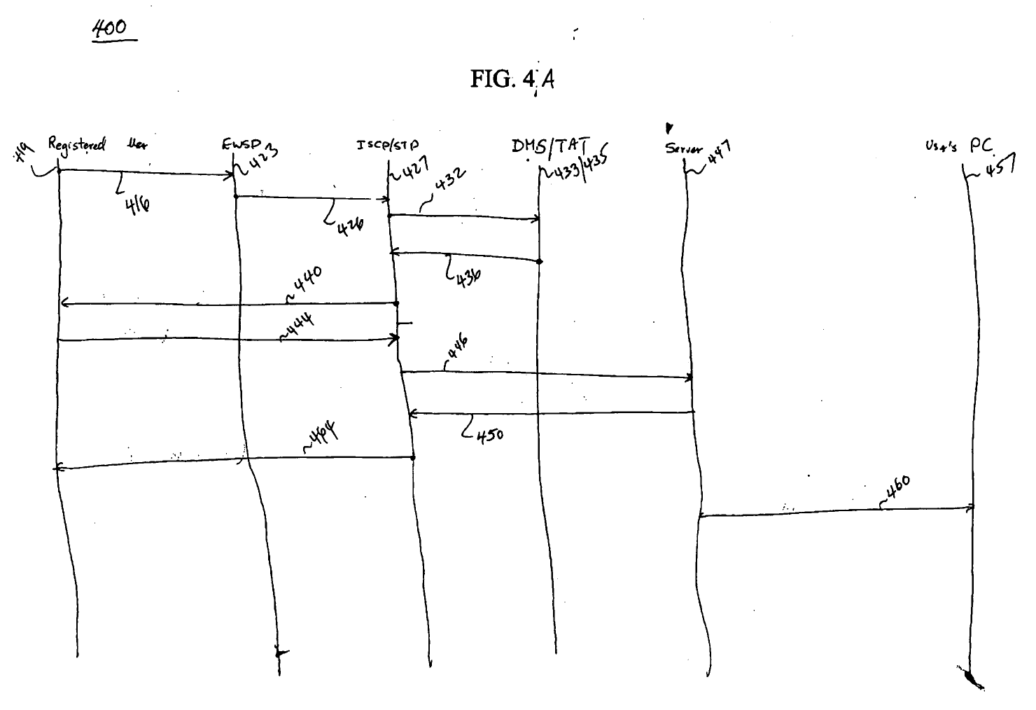

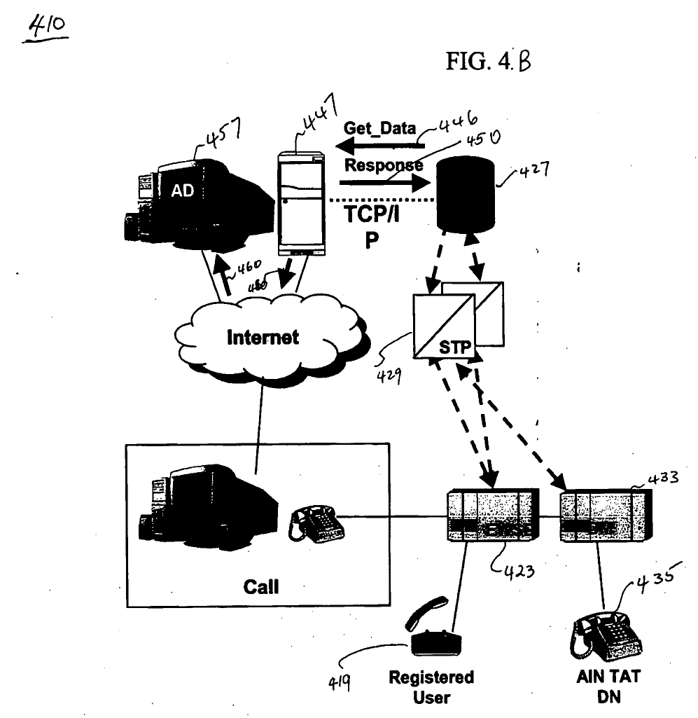

Turning now to FIGS. 4A and 4B, there is shown a process flow 400 and a system 410 on which the process flow 410 may be implemented. In accordance with FIG. 4A, the process is initiated with a request from a registered user for an ad-on-demand, 416. The request 416 is preferably initiated using via telephone call from telephone 419. The request 416 may be initiated using an 800 or 888 number, e.g., 888-AD-ON-DMD. The request 416 is received at a service switching point 423. As previously discussed, in the preferred embodiment the service switching point 423 may comprise an EWSD switch that is coupled to a DMS switch. In general, the service switching point may comprise a plurality of electronic switches that are used to establish call routes in the network. The service switching point 423 then launches an advanced intelligent network specific data string (SDS) trigger 426 to an integrated service control point 427. As shown in FIG. 4A, the SDS trigger 426 is preferably routed through an STP 429 as discussed above.

The ISCP 427 then routes the call 432 to a switch 433 having a line subscribed to an advanced intelligent networking termination attempt trigger 435. The switch 433 then initiates an advanced intelligent networking termination attempt trigger query 436 to the ISCP 427. The ISCP 427 then requests that the user enter a unique identifier associated with the advertisement of interest 440. The unique identifier may comprise any combination of alphanumeric characters that can be entered via a phone, such as phone 419.

The user responds to the query 440 at step response 444. The ISCP then provides the unique identifier associated with the ad and information sufficient to identify the caller, 446, an ad-on-demand server 447. The information to identify the caller preferably comprises the calling number. The server 447 then determines whether the calling number corresponds to a registered user. In this case, the user is registered. Therefore, the server sends a confirmation, 450, to the integrated service control point 427 indicating that the user is registered. The requested ad may then be downloaded to the server 447 to the user computer 457 as shown at step 460. As shown in FIG. 2A, the integrated service control point 427 may also play an announcement to the calling party, 464 via phone 419 indicating completion of the request. The announcement may comprise an audible message such as “Thank you for using this service.” The message may be played before or after the server 447 sends the ad to the user computer 457.

In view of the foregoing, the present invention advantageously allows a consumer to request and receive the ads that they desire. For example, billboards, newspaper advertisements, or other forms of advertisements may be assigned unique ad numbers. These numbers are preferably be visibly affixed to the ads themselves. Upon seeing an ad of interest, a consumer may dial a number associated with an ad-on-demand service, input the unique ad number and have the ad or information relating to the ad deliver to their email account. In accordance with the different aspects of the present invention, consumers would receive only those ads that they are interested in. This would allow advertisers, merchants and manufacturers to be able to obtain feedback on the effectiveness of their advertising campaigns. This would also enable these entities to better direct their advertising dollars to those forms of advertisements, e.g., billboards versus magazines, that are most effective.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for distributing advertisements, comprising:
initiating a telephone call from a telephone;
sending a request for an advertisement from the telephone, the request including a unique identifier associated with the advertisement and a telephone number associated with the telephone;
receiving the request at a network server;
processing the request at the network server including determining whether the telephone number is associated with a registered user; and
transmitting the advertisement from the network server to an account associated with the registered user if the server determines that the telephone number is associated with a registered user.

2. The method of claim 1, further comprising routing the telephone call to a registration server if the server determines that the telephone number is not associated with a registered user.

3. The method of claim 2, further comprising registering, at the registration server, the user's telephone number as a registered user.

4. The method of claim 3, wherein registering comprises sending a confirmation message to a personal computer associated with the user over the Internet.

5. The method of claim 1, wherein sending further comprises sending the request to the server over a telecommunications network employing advanced intelligent network technology.

6. The method of claim 5, wherein the advanced intelligent network technology comprises a service control point having a generic data interface that is connected to the server.

7. The method of claim 1, wherein transmitting comprises sending an email that includes the advertisement over the Internet to an email account associated with the registered user.

8. The method of claim 1, wherein the telephone call is initiated over a cellular telephone network.

9. A method for providing an ad-on-demand service, comprising:
receiving an ad-on-demand request from a telephone at telephone switching system;
routing the ad-on-demand request from the telephone switching system to an integrated service control point;
transforming, at the integrated service control point, the ad-on-demand request into one or more data packets;
sending the one or more data packets to a server; and
processing, at the server, the one or data packets to determine whether an ad associated with the ad-on-demand request should be routed to a client computer associated with the telephone.

10. The method of claim 9, wherein the ad-on-demand request comprises a telephone number associated with the telephone and ad-on-demand identifier associated with a product or a service.

11. The method of claim 9, wherein sending comprises sending the one or more packets using the TCP/IP protocol.

12. The method of claim 9, wherein routing comprises routing one or more messages associated with the ad-on demand request over a signaling network.

13. The method of claim 12, wherein the signaling network comprises a switching system seven (SS7) signaling transfer point.

14. The method of claim 10, wherein processing further comprises sending an email message to a computer connected to the server and associated with the telephone over a data communication network distinct from a telephone network comprising the telephone switching system and the integrated service control point if the telephone number is associated with a registered user.

15. The method of claim 10, the data communication network comprises the Internet and the telephone network comprises the public switched telephone network.

16. The method of claim 10, wherein processing further comprises sending an audible message to the telephone over the telephone network if the telephone number cannot be associated with a registered user.

17. The method of claim 9, wherein receiving the ad-on-demand request comprises receiving a telephone number associated with the ad-on-demand service.

18. The method of claim 17, further comprising, prior to routing the ad-on-demand request, requesting ad-on-demand identifier associated with a product or a service.
